(19) United States
(12) Patent Application Publication
(10) Pub. No.: US 2006/0154733 A1
(43) Pub. Date: Jul. 13, 2006

(54) Light box structure for game machine

(76) Inventor: David Wu, Taipei (TW)

Correspondence Address: BRUCE H. TROXELL;SUITE 1404, 5205 LEESBURG PIKE, FALLS CHURCH, VA, 22041, US

(21) Appl. No.: 11/033,287

(22) Filed: Jan. 12, 2005

(51) Int. Cl. A63F 13/00

(52) U.S. Cl. 463/46; 463/47

(57) ABSTRACT

An improved structure of light box for a game machine, wherein the light box comprises a body with a predetermined side thickness and a covering frame which is mounted thereon with a panel; the body of the light box and the covering frame with the panel are mounted therebetween with a reflective frame made of transparent material, the reflective frame is defined between the body of the light box and the covering frame with the panel after being assembled and positioned to form a transparent outer peripheral frame that reveals at the external surface of the light box and can be seen from different positions around said game machine. Thus the improved light box is formed and can increase displaying function of the light effect of the game machine to attract attention of the consumers in different directions in site.

### BACKROUND OF THE INVENTION

1. Field of the Invention

The present invention is related to an improved structure of light box for a game machine, and especially to an improved device for increasing displaying function of a light box for a game machine.

2. Description of the Prior Art

Game machines include various types such as slot machines, fruit machines and poker machines, and prevail in various types of amusement places of the whole world. In the recent years, many governments authorized to legalize game machines, and authorization for game machines tend to grow, because this can have the advantages of being benefit to management and increasing tax revenue.

The feature of such game machines available presently is that they must continuously have new designed games, otherwise, they will be hard to attract consumers to keep on desiring to play games, this is why normal manufacturers of game machines all want to cooperate with the market development for new game machines and types of games.

In addition to the difference among the types of games, the structures and visual senses of the appearances of game machines themselves are also the main facts of whether they can attract consumers in displaying. Therefore, such game machines generally are endued in appearance with features of richness in sound and light modeling. The apparatuses for game machines that can form the necessary light effect include the equipment such as light boxes that can generate illumination or light flashing of various colors in operation of the game machines.

However, most of the structures of the game machines available presently are provided with light sources in their light boxes, while the light sources are reflected onto the surface panels of the light boxes. By direct irradiation of the light sources or controlling for various modes of flashing, light effect desired can be formed. Light boxes of conventional game machines of such kind mostly are irradiated directly from the panels of the light boxes, their light effect can only be generated from their front sides; when consumers are at the positions not facing to the front sides, they are hard to see the light effect, the function of displaying of the game machines is evident insufficient.

### SUMMARY OF THE INVENTION

The object of the present invention is to provide an improved structure of light box for a game machine that can increase displaying function the light effect of the game machine to attract attention of the consumers in different directions in site.

To get the above object, the light box of the present invention is composed of a body with a predetermined side thickness and a covering frame which is mounted thereon with a panel; the body of the light box stated above and the covering frame with the panel are mounted therebetween with a reflective frame made of transparent material, the reflective frame is defined between the body of the light box and the covering frame with the panel after being assembled and positioned to form a transparent outer peripheral frame that reveals at the external surface of the light box and can be seen from different positions around the game machine.

In a preferred embodiment, the body of the light box and the covering frame with the panel respectively have holes and studs mutually aligned and connected, the reflective frame is provided with connecting sleeves between the holes and studs respectively on the body of the light box and the covering frame with the panel.

The present invention will be apparent in its novelty and features after reading the detailed description of the preferred embodiment thereof in reference to the accompanying drawings.

### BRIEF DESCRIPTION OF THE DRAWINGS

FIG. 1 is a perspective view of a preferred embodiment of the present invention;

FIG. 2 is an anatomic perspective view showing elements of FIG. 1;

FIG. 3 is a sectional view taken from FIG. 1;

FIG. 3A is a partially enlarged sectional view taken from FIG. 3A.

### DETAILED DESCRIPTION OF THE PREFERRED EMBODIMENT

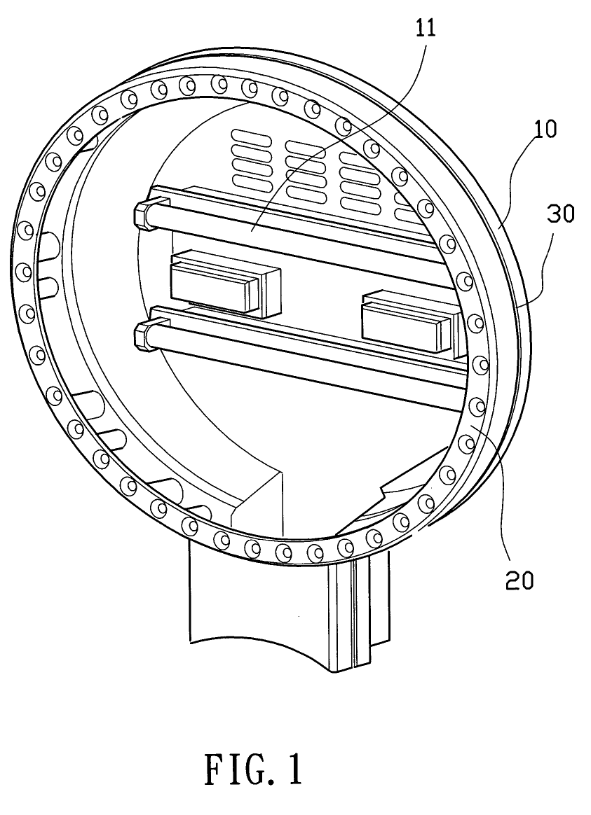

Referring to FIG. 1, in the embodiment shown, a light box comprises a body 10 with a predetermined side thickness and a covering frame 20 normally made of material being nontransparent, the covering frame 20 can be mounted thereon with a transparent panel (not shown).

The body 10 is provided therein with light sources 11 and related sound and light emitting means; when the body 10 and the covering frame 20 are assembled with each other, the light effect generated by the light sources 11 can be displayed through the transparent panel, however, it is deficient in that light can only be emitted from their front sides.

As shown in FIGS. 1-3, the present invention mainly has the body 10 of the light box stated above and the covering frame 20 with the panel mounted therebetween with a reflective frame 30 preferably made of transparent material, the reflective frame 30 is defined between the body 10 of the light box and the covering frame 20 with the panel after being assembled and positioned to form a transparent outer peripheral frame that reveals at the external surface of the light box and can be seen from different positions around the game machine.

Although the above stated embodiment uses an annular light box, those skilled in this art know that the light boxes of such game machines can also be of various modeling.

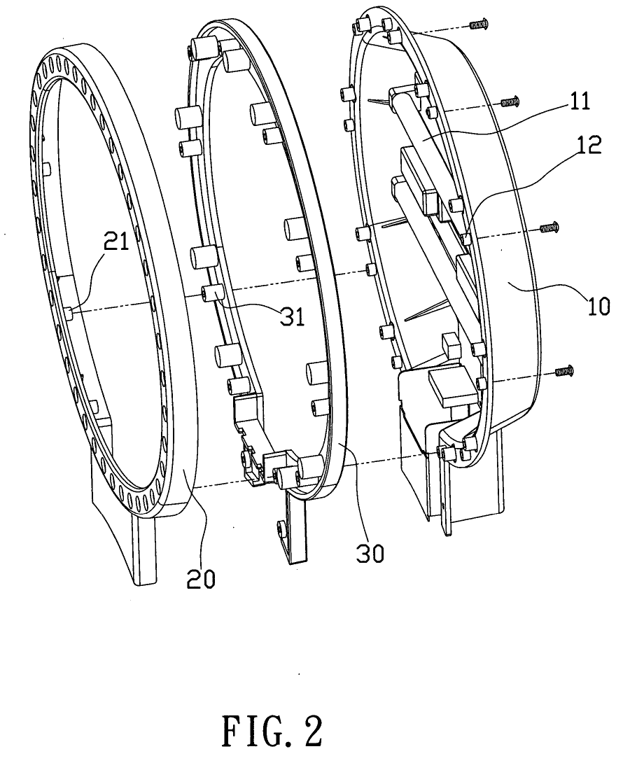

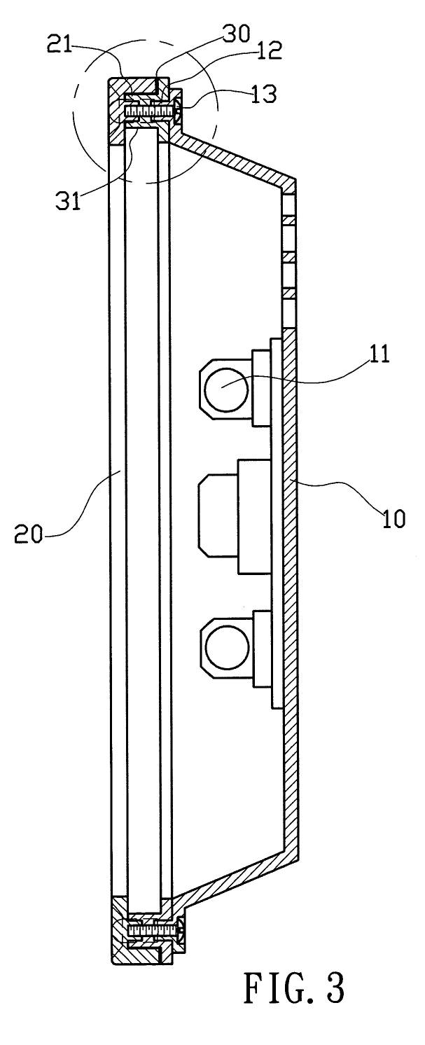

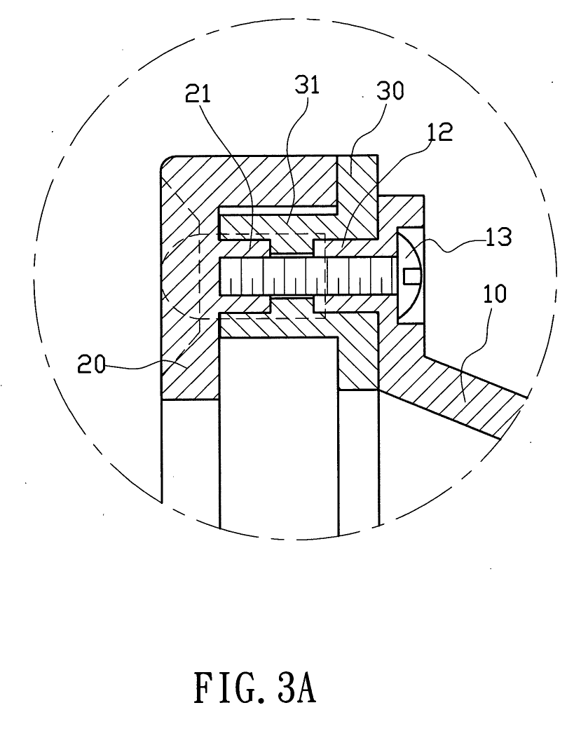

As shown in FIGS. 2, 3 and 3A, in the preferred embodiment, the reflective frame 30 of the present invention is provided with connecting sleeves 31 between a plurality of holes 12 and studs 21 respectively on the body 10 of the light box and the covering frame 20 with the panel; and the body 10 of the light box and the covering frame 20 with the panel respectively are connected with the holes 12 and studs 21 mutually aligned, then are locked together with bolts 13.

An entire improved structural of light box of the present invention forms a transparent outer peripheral reflective frame 30 at the middle position of the peripheral side thereof after assembling, which reflective frame 30 reveals to the outside; when the light sources 11 in the body 10 irradiate or flash, the entire periphery of the reflective frame 30 made of transparent material altogether has a function of emitting light, so that consumers not only can be attracted at the front side of a game machine, but also can feel the light effect at other sides.

The function of emitting light of the light box of a game machine of the present invention can more attract attention of the consumers in different directions in site; it can increase displaying function the sound and light, and thus has the value of industrial utility.

The embodiment given is only for illustrating the present invention, and not for giving any limitation to the scope of the present invention. It will be apparent to those skilled in this art that various modifications or changes without departing from the spirit of this invention, such as make a light box a shape of any of various shapes in addition to an annular one, shall also fall within the scope of the appended claims.

1. An improved structure of light box for a game machine, wherein said light box comprises a body with a predetermined side thickness and a covering frame which is mounted thereon with a panel, and is characterized in that: said body of said light box and said covering frame with said panel are mounted therebetween with a reflective frame made of transparent material, said reflective frame is defined between said body of said light box and said covering frame with said panel after being assembled and positioned to form a transparent outer peripheral frame that reveals at the external surface of said light box and is adapted for being seen from different positions around said game machine.

2. The improved structure of light box for a game machine as defined in claim 1, wherein said body of said light box and said covering frame with said panel respectively have holes and studs mutually aligned and connected, said reflective frame is provided with connecting sleeves between said holes and studs respectively on said body of said light box and said covering frame with said panel.
